(19) United States
(12) Patent Application Publication
(10) Pub. No.: US 2025/0153116 A1
(43) Pub. Date: May 15, 2025

(54) MACROPOROUS GRAPHENE MEMBRANE

(71) Applicant: Texas Tech University System, Lubbock, TX (US)

(72) Inventors: Mohammadmahdi Malmali, Lubbock, TX (US); Amit K. Thakur, Lubbock, TX (US)

(21) Appl. No.: 18/838,750

(22) PCT Filed: Feb. 15, 2023
(86) PCT No.: PCT/US2023/013137

§ 371 Date: Aug. 15, 2024

Related U.S. Application Data
(60) Provisional application No. 63/310,458, filed on Feb. 15, 2022.

(51) Int. Cl. B01D 71/02; B01D 61/14; B01D 67/00; B01D 69/10

(52) U.S. Cl. CPC B01D 71/0211; B01D 61/145; B01D 67/00415; B01D 69/107

(57) ABSTRACT

A mechanically robust LIG membrane can be fabricated by directly lasing a poly(ether) sulfone (PES) membrane support, the PES membranes being formed through a NIPS technique treated with Glycerol to control the pore collapse upon drying, to create a graphene layer on the top and/or bottom of the PES membrane.

### CROSS REFERENCE TO RELATED APPLICATIONS

This patent application claims the priority and benefit under 35 U.S.C. § 119(e) of U.S. Provisional Patent Application Ser. No. 63/310,458 filed Feb. 15, 2022, entitled “MACROPOROUS GRAPHENE MEMBRANE.” U.S. Provisional Patent Application Ser. No. 63/310,458 is herein incorporated by reference in its entirety.

### TECHNICAL FIELD

Embodiments are generally related to the field of macroporous structures. Embodiments are also generally related to the field of filters. Embodiments are further related to membranes. Embodiments are also related to fluid treatment. Embodiments are further related to filtering water. Embodiments are also related to graphene membranes. Embodiments are further related to laser-induced graphene membranes with stable microporous structures.

### BACKGROUND

A cornerstone of civilization rests on our ability to purify water. Since time immemorial we have sought solutions to ensure water sources are suitable and safe for human consumption. Over time numerous water filtering solutions have been developed. As the solutions have become more sophisticated, we have increasingly found ways to improve filtering. New filters are often able to filter increasingly small contaminants.

Graphene is a two-dimensional single-layer material that has attracted great interest because of its unique physiochemical and mechanical properties. As such, graphene and its derivatives are being explored for numerous purposes in the fields of energy, electronics, and other applications. While graphene shows great promise, it also currently has numerous limitations. Among these, are that the graphene structure is generally unstable and therefore not suitable for bulk filtration applications.

Given the increasing demand for improved filters, there is a need for systems and methods for graphene membranes with stable macroporous structures as disclosed herein.

### SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the disclosed embodiments to provide a filter.

It is another aspect of the disclosed embodiments to provide systems and apparatuses for filtering fluids.

It is another aspect of the disclosed embodiments to provide methods and systems for inducing graphene membranes on stable macroporous structures.

It is another aspect of the disclosed embodiments to provide methods, systems, and apparatuses for fabricating laser-induced graphene membranes.

It will be appreciated that the methods and systems can be achieved according to the embodiments disclosed herein. In an embodiment, a filter fabrication method comprises forming an ultrafiltration (UF) membrane, immersing the UF membrane in a glycerol solution, and lasing a surface of the membrane. In an embodiment, the membrane comprises poly(ethersulfone).

In an embodiment of the method lasing a surface of the membrane further comprises lasing a top surface of the membrane. In an embodiment of the method, lasing a surface of the membrane further comprises lasing a bottom surface of the membrane. In an embodiment of the method, lasing a surface of the membrane further comprises forming a graphene layer on the surface of the membrane. In an embodiment of the method, lasing a surface of the membrane further comprises adjusting parameters of a laser according to desired properties of the graphene layer. In an embodiment of the method, lasing a surface of the membrane further comprises applying a laser comprising a Carbon dioxide infrared laser. In an embodiment of the method, forming a membrane further comprises a nonsolvent induced phase separation form a polymer doped solution.

In an embodiment, a filter fabrication method comprises immersing an ultrafiltration (UF) membrane in a glycerol solution, removing excess glycerol from the UF membrane, and lasing a surface of the membrane. In an embodiment of the method, lasing a surface of the membrane further comprises lasing a top surface of the membrane. In an embodiment of the method, lasing a surface of the membrane further comprises lasing a bottom surface of the membrane. In an embodiment of the method, lasing a surface of the membrane further comprises forming a graphene layer on the surface of the membrane. In an embodiment of the method, lasing a surface of the membrane further comprises adjusting parameters of a laser according to desired properties of the graphene layer. In an embodiment of the method, lasing a surface of the membrane further comprises applying a laser comprising a Carbon dioxide infrared laser. In an embodiment the method further comprises drying the UF membrane after excess glycerol is removed. In an embodiment the method further comprises forming a UF membrane. In an embodiment, the method further comprises dissolving poly(ethersulfone) (PES) in N-Methyl-2-Pyrrolidone (NMP) to create a solution, cooling the solution to room temperature, removing air bubbles from the solution, spreading the solution on a substrate, immersing the solution on the substrate in a water coagulation bath, and removing residual solvent.

In an embodiment, a filter comprises a poly(ethersulfone) (PES) membrane, a graphene layer formed on the PES membrane, a microporous structure associated with the graphene layer, and a bottom surface. In an embodiment, the PES membrane comprises a PES Veradel 3000P Mw˜65,000 g mol−1. In an embodiment, the graphene layer is formed by lasing the PES membrane.

### BRIEF DESCRIPTION OF THE FIGURES

The accompanying figures, in which like reference numerals refer to identical or functionally similar elements throughout the separate views and which are incorporated in and form a part of the specification, further illustrate the embodiments and, together with the detailed description, serve to explain the embodiments disclosed herein.

FIG. 1 depicts a method for manufacturing a macroporous graphene structure, in accordance with the disclosed embodiments;

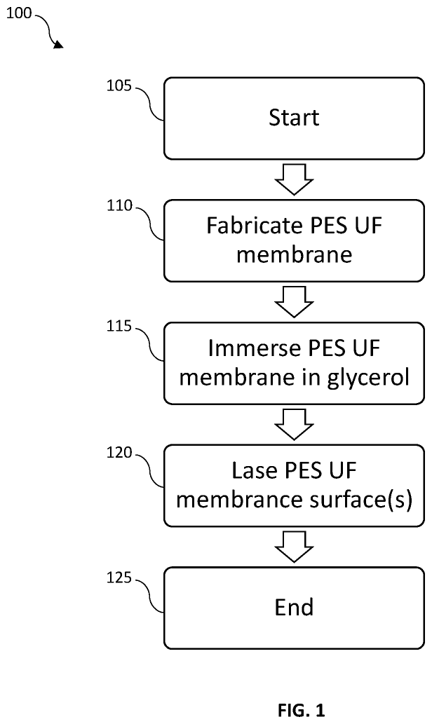

FIG. 2 depicts a macroporous graphene membrane, in accordance with the disclosed embodiments;

FIG. 3 depicts steps associated with a method for preparing a membrane, in accordance with the disclosed embodiments;

FIG. 4 depicts steps associated with a method for immersing a membrane in glycerol, in accordance with the disclosed embodiments;

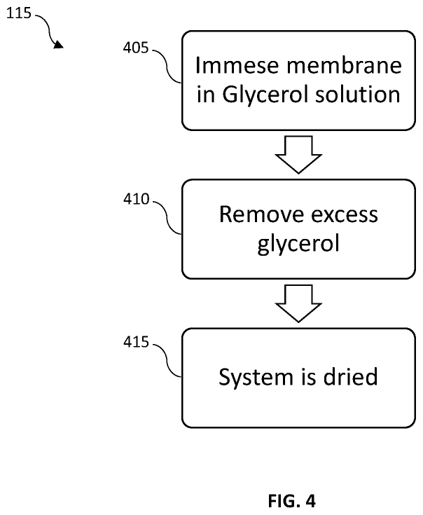

FIG. 5 depicts steps associated with a method for lasing a membrane, in accordance with the disclosed embodiments;

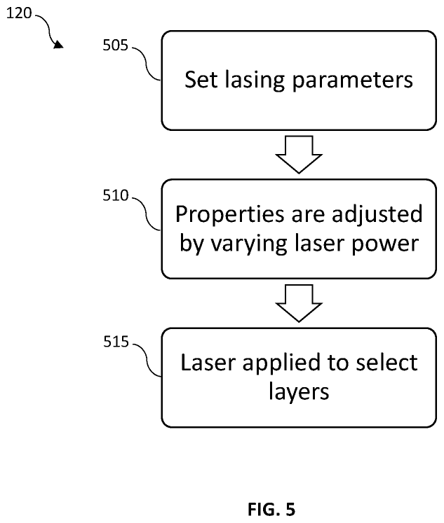

FIG. 6A depicts a graph of performance parameters and flow rate, in accordance with the disclosed embodiments;

FIG. 6B depicts a chart of rejection percentage as a function of molecular weight for various materials, in accordance with the disclosed embodiments;

FIG. 7 depicts an array of photographs of a macroporous structure, in accordance with the disclosed embodiments;

FIG. 8 depicts a block diagram of a computer system which is implemented in accordance with the disclosed embodiments;

FIG. 9 depicts a graphical representation of a network of data-processing devices in which aspects of the present embodiments may be implemented; and

FIG. 10 depicts a computer software system for directing the operation of the data-processing system depicted in FIG. 8, in accordance with an example embodiment.

### DETAILED DESCRIPTION

Embodiments and aspects of the disclosed technology are presented herein. The particular embodiments and configurations discussed in the following non-limiting examples can be varied, and are provided to illustrate one or more embodiments, and are not intended to limit the scope thereof.

Reference to the accompanying drawings, in which illustrative embodiments are shown are provided herein. The embodiments disclosed can be embodied in many different forms and should not be construed as limited to the embodiments set forth herein; rather, these embodiments are provided so that this disclosure will be thorough and complete, and will fully convey the scope of the embodiments to those skilled in the art. Like numbers refer to like elements throughout.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit, and scope of the invention. All such similar substitutes and modifications apparent to those skilled in the art are deemed to be within the spirit, scope and concept of the invention as defined by the appended claims.

Embodiments disclosed herein are directed to laser-induced graphene (LIG) materials. In particular, the embodiments relate to a simple and low-cost method that enables the fabrication of a robust LIG ultrafiltration (UF) membrane. The disclosed mechanically robust LIG membranes are facilely fabricated by direct lasing with a laser, such as a CO₂ infrared laser, onto a poly(ethersulfone) (PES) membrane support. In certain embodiments, the PES membranes can be subject to a non-solvent induced phase separation (NIPS) technique and treated with Glycerol to control pore collapse upon drying and preserve the nanostructure features of the polymeric substrate. The treatment with Glycerol allows for LIG formation without any changes to the membrane's underlying nanoporous structure. The PES (B)-LIG-HP membrane fabricated by CO₂ lasing on the bottom layer provides up to 4 times higher flux as compared to other membranes while providing equal bovine serum albumin (BSA) rejection levels.

The disclosed embodiments include methods 100 for fabricating robust LIG UF membrane filters. In certain embodiments, this can include methods adapted to a scalable roll-to-roll process. The method starts at step 105.

In certain embodiments, a PES UF membrane can be fabricated as disclosed herein, as shown at 110. PES UF membranes can be prepared via the NIPS method and pretreated with a glycerol solution to maintain the microstructure upon drying.

The lased membrane can then be immersed, at step 115, in Glycerol which allows preserving the nanostructure on a PES membrane, without destroying the underlying membrane structure.

Next, at step 120, a graphene layer can be created by lasing the membrane. In certain embodiments, this can include the use of a CO₂ infrared laser applied on the top and/or bottom layer of the PES UF membrane. Irradiation of the Glycerol treated PES membranes induce photothermal transformation of the bottom and/or top surface to LIG. The water permeation and the rejection of the membrane can be tuned by changing the laser parameters. The LIG membrane is resilient to disintegration or loss of LIG in water, acid, and basic solutions. The method ends at step 125.

The disclosed embodiments further provide filters with excellent mechanical properties and stability, with powerful resistance to sonication and to water soakage. The disclosed embodiments are thus directed to highly robust LIG membranes, with excellent permeability and separation efficiency, which can be useful in many applications including, but not limited to, pharmaceutical techniques, water treatment technology, etc.

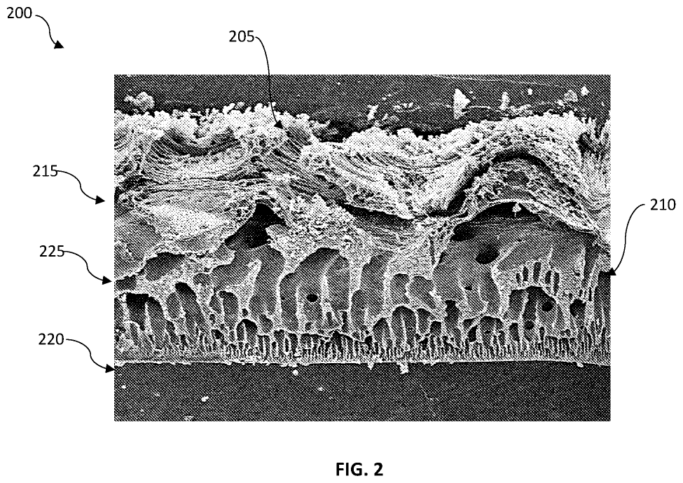

FIG. 2 illustrates a cross-sectional image of laser-induced graphene membrane system filter 200 with a stable macroporous structure in accordance with the disclosed embodiments. In certain embodiments, the membrane system filter 200 can comprise a polyethersulfone (PES) substrate, such as a PES Veradel 3000P Mw˜65,000 g mol⁻¹, or other such material (e.g., a PES membrane). The resulting laser-induced graphene membrane system 200 can comprise a graphene layer 205, with microporous structure 210 with a bottom surface 220.

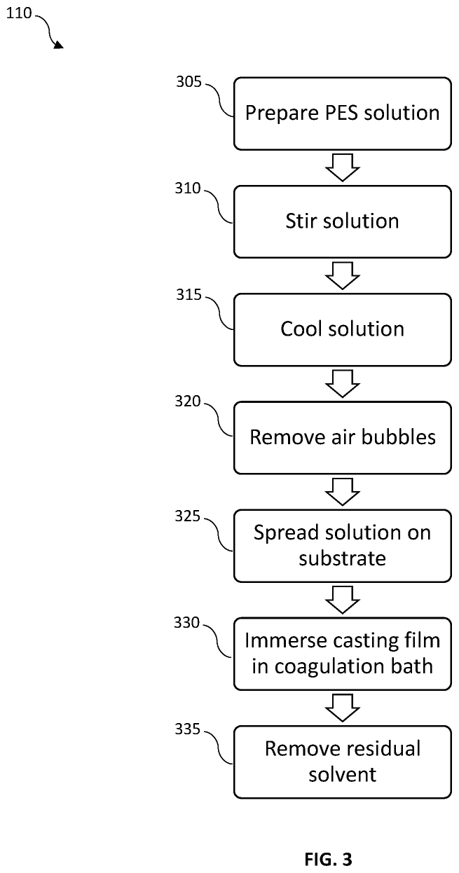

The PES UF membrane can be fabricated with a nonsolvent induced phase separation (NIPS) method from a polymer dope solution. FIG. 3A illustrates an exemplary method for fabricating a PES UF membrane as illustrated at step 110. In certain embodiments, a 15 wt. % PES solution can be prepared at step 305 by dissolving PES in N-Methyl-2-Pyrrolidone (NMP). The solution can be stirred constantly, at step 310 while being held at a constant temperature. For example, the solution can be stirred constantly at 60° C. for 6 hours. The polymer solution can then be cooled to room temperature at step 315, and the stirring can be continued as necessary (e.g., for 12 hours). Air bubbles that may appear due to the stirring of the casting solutions can be removed at step 320, by leaving the prepared solutions for a selected time without stirring.

At step 325, the solution can be spread on a plate (preferably a glass plate) with, for example, a stainless-steel casting knife. A gap height of 600 μm can be used but other dimensional characteristics are possible. Next, the casting film can be immersed into a water coagulation bath at step 330 (at ˜20° C.) to initiate the NIPS process. After that, the fabricated membrane can be placed in a fresh DI water bath and left overnight to remove residual solvent at step 335.

Next, as illustrated at step 115, the wet membrane can be immersed in a Glycerol solution. FIG. 3B illustrates steps associated with the immersion in Glycerol at step 115. In an exemplary embodiment, at step 405, the Glycerol solution can comprise a 20% Glycerol solution held at room temperature for 60 min. At step 410 the excess glycerol can be removed, for example, using a cotton piece. Finally, at step 415 the obtained PES UF can be dried for example, at 50° C. in a convection oven for 48 hours.

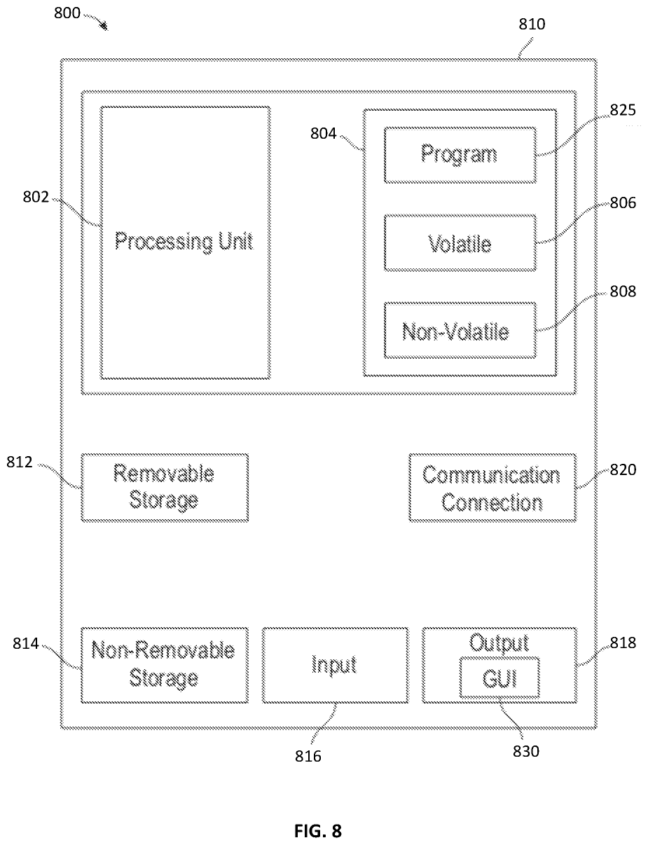

In certain embodiments, the bottom layer 220 and/or top layer 215 of PES 225 can be irradiated with a laser system as illustrated at step 125. FIG. 3C illustrates aspects of the method associated with the lasing step 125. For example, in an embodiment, a 10.6 μm CO₂ laser marking machine (Universal Laser System, VLS 3.6, 40 W) can be used for lasing the PES membrane. Parameters associated with the lasing such as laser power, image density, and scan rate, can be selected at step 505. In certain embodiments, the laser power can be 6-8% of full power 40 W, the image density can be 1000 pulses per inch, and the scan rate can be 20% and can be used during the fabrication under ambient conditions. In certain embodiments, the laser can be controlled with a computer system and associated software as illustrated in FIGS. 8-10, to ensure the desired laser parameters are applied to achieve the desired graphene layer. In certain embodiments, the software can allow a user to enter filtering parameters and can adjust the laser parameters to ensure the resulting structure meets the desired specifications.

Lasing parameters can be selected according to design considerations. In exemplary embodiments, this can include PES (B)-LIG-LP (6% power on bottom surface) PES (B)-LIG-MP (7% power on bottom surface) PES (B)-LIG-HP (8% power on bottom surface), PES (T)-LIG-LP (6% power on the top surface), PES (T)-LIG-MP (7% power on the top surface) and PES (T)-LIG-HP (8% power on the top surface) membranes, where LP, MP, and HP denote the power of the laser as low, medium and high power, respectively. These exemplary parameters are illustrated in Table 1:

TABLE 1

| | LIG | Laser power | Laser speed |
|---|---|---|---|
| Samples | Surface | (%) | (%) |
| PES (B)-LIG-LP | Bottom | 6 | 20 |
| PES (B)-LIG-MP | Bottom | 7 | 20 |
| PES (B)-LIG-HP | Bottom | 8 | 20 |
| PES (T)-LIG-LP | Top | 6 | 20 |
| PES (T)-LIG-MP | Top | 7 | 20 |
| PES (T)-LIG-HP | Top | 8 | 20 |

It should be noted that, in certain embodiments, the properties of the LIG UF membranes can be varied by varying the power of the laser at step 510. The laser is applied to various surfaces in the system 200, at step 515. For example, the laser can be applied to the bottom macroporous sublayer of asymmetric PES UF membrane which can be converted to LIG, while the top dense skin layers are maintained. Further, the selective top layer of the PES UF membrane can be converted to LIG, with the highly nanoporous LIG embedded in the substructure of the membrane. This configuration provides excellent rejection through the LIG layer, without compromising flow rate through the macroporous structure.

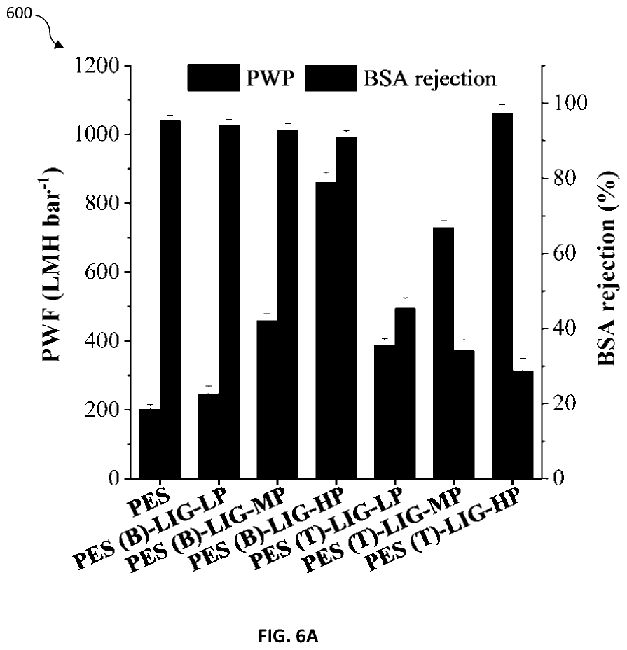

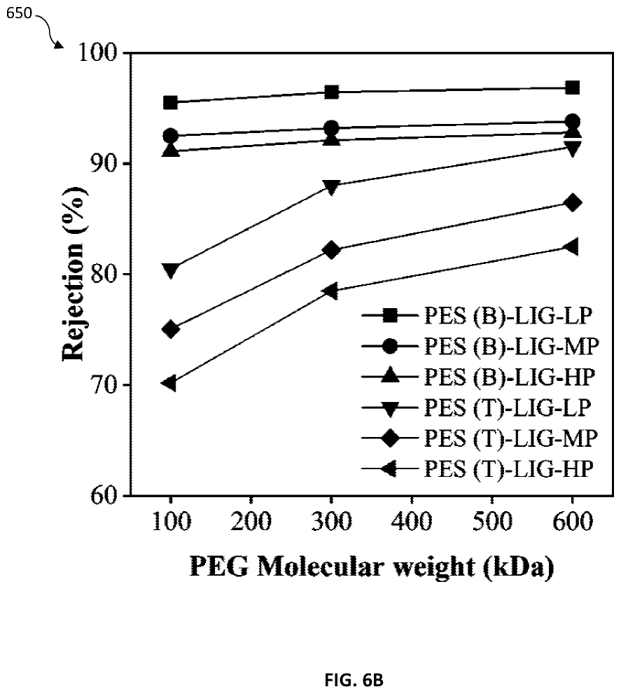

Water permeability and BSA rejection were performed on exemplary samples to assess the performances of the series of LIG-UF membranes 200, and the permeability and BSA rejection were compared with the control PES membrane as illustrated by chart 600 in FIG. 6A and chart 650 in FIG. 6B.

When the bottom layer of PES was lased at lower (6%) power, the corresponding PES (B) LIG-LP membrane exhibited the lowest pure water flux of 245 LMH bar⁻¹ and highest BSA rejection of 94.2%, while the PES (B)-LIG-MP and PES (B)-LIG-HP membrane which was lased with 7 and 8% power had very high water flux of 457 and 865 LMH bar⁻¹. However, a slight decrease (92.8 and 90.9%, respectively) in BSA rejection as compared to PES (B) LIG-LP was observed for PES (B) LIG-LP and PES (B)-LIG-HP.

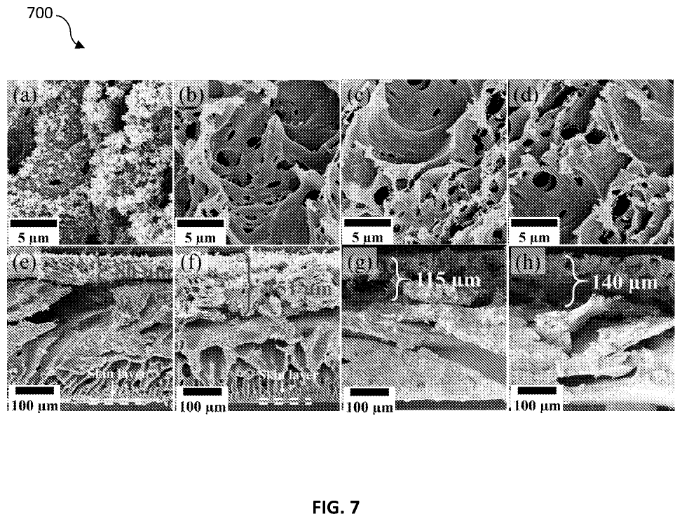

The higher water flux for (B)-LIG-HP is the result of more graphitization at higher laser power. This is also supported by the cross-section image array 700 in FIG. 7, where the thickness of the resulting PES (B) LIG-HP and PES (T)-LIG-HP membranes is ˜151 μm and ˜140 μm is illustrated.

Moreover, the flux of the PES (B)-LIG-HP membrane can be more than 4 times higher than that of a control PES membrane which can reach 201 LMH bar⁻¹ with a comparable BSA rejection rate, as shown in FIG. 6A. Lasing the selective layer of PES significantly increases the porosity of the PES (T)-LIG membranes, leading to high pure water flux and low BSA rejection. Comparison of the series of PES (T)-LIG-LP, MP and HP membranes, PES (T)-LIG-LP shows the relatively lowest flux (386 LMH bar⁻¹), with ˜45% BSA rejection. As the power of the laser increases, the water flux dramatically increases to 1062 LMH bar⁻¹ while BSA rejection decreases to ˜29% for the PES (T)-LIG-HP membrane.

Overall, these results indicate that the PES (B)-LIG-LP, MP, and HP membranes offer improved filtration as compared to PES (T)-LIG-LP, MP, and HP membranes regardless of maintaining the bottom skin dense layer. The lower BSA rejection in the PES (T)-LIG-LP series of membranes can be attributed to the macro- and nanoporosity as the active dense layer which is converted to graphene. The MWCO values of the LIG UF membranes can be evaluated by measuring rejection of PEG 100, 300, and 600 kDa, as illustrated in FIG. 6B. The MWCO value is the molecular weight of PEG corresponding to the 90% rejection of the membranes. The PES (B)-LIG-LP, MP, HP, and PES (T)-LIG-LP, membrane exhibits an MWCO˜90 kDa, while the PES (T)-LIG-MP and HP, has MWCO>600 kDa.

Membrane stability after lasing remains one of the major advantages of the disclosed technology. Sonication of the membrane filters for an extended period of time can be used to determine whether the graphene layer detaches and exfoliates stacked nanosheets. The mechanical stability of the LIG UF membranes can be examined, for the disclosed exemplary embodiments, by exposure to ultrasonic agitation at RT for 1 hour followed by 50° C. for 2 hours in DI water. All the membranes are very stable and remain in their original structure. LIG UF membranes can further be immersed in acidic and alkaline solution under sonication. The disclosed membranes are highly stable in both acidic (5M) and alkaline (5M) conditions and do not exhibit any signs of disintegration or loss of LIG. Additionally, the stability of PES (B)-LIG-HP and PES (T)-LIG-HP membrane can further be explored on a dead-end filtration device after 4 hours of ultrasonic agitation, and the results show stable performance.

The permeability and rejection differences between the membranes before or after treatment are <2%. In addition to the ultrasonic agitation, a tape test for assessing the durability of the membranes can be performed. When the piece of adhesive tape is pressed onto the surface of PES (B)-LIG-HP and (PES) (T)-LIG-HP and removed, the LIG is still attached and the tape is visually clean with no damage to the membranes surface, giving evidence that the LIG formation imparts improved mechanical stability to the LIG membrane surface.

The acid and alkali resistance of well-optimized PES (B)-LIG-HP and PES (T)-LIG-HP membranes can be evaluated by a soaking process in 37% HCl and 15% NaOCl. The results show that both membranes have no disintegration, and they exhibit high acid-alkali resistance stability for seven days.

The disclosed membranes possess prominent mechanical structures with both strength and flexibility. The LIG UF membrane can be twisted completely and folded at random without breakage which displays structural superiority in practical application.

FIGS. 8-10 are provided as exemplary diagrams of data-processing environments in which embodiments may be implemented. It should be appreciated that FIGS. 8-10 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

A block diagram of a computer system 800 that executes programming for implementing parts of the methods and systems disclosed herein is provided in FIG. 8. A computing device in the form of a computer 810 configured to interface with controllers, peripheral devices, and other elements disclosed herein may include one or more processing units 802, memory 804, removable storage 812, and non-removable storage 814. Memory 804 may include volatile memory 806 and non-volatile memory 808. Computer 810 may include or have access to a computing environment that includes a variety of transitory and non-transitory computer-readable media such as volatile memory 806 and non-volatile memory 808, removable storage 812 and non-removable storage 814. Computer storage includes, for example, random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage, or other magnetic storage devices, or any other medium capable of storing computer-readable instructions, as well as data including image data.

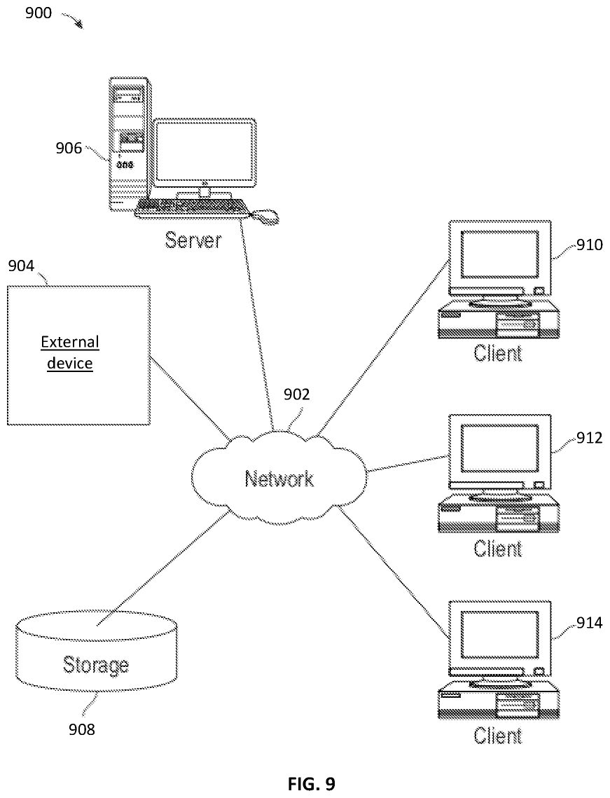

Computer 810 may include, or have access to, a computing environment that includes input 816, output 818, and a communication connection 820. The computer may operate in a networked environment using a communication connection 820 to connect to one or more remote computers, remote sensors and/or controllers, detection devices, hand-held devices, multi-function devices (MFDs), speakers, mobile devices, tablet devices, mobile phones, Smartphone, or other such devices. The remote computer may also include a personal computer (PC), server, router, network PC, RFID enabled device, a peer device or other common network node, or the like. The communication connection may include a Local Area Network (LAN), a Wide Area Network (WAN), Bluetooth connection, or other networks. This functionality is described more fully in the description associated with FIG. 9 below.

Output 818 is most commonly provided as a computer monitor, but may include any output device. Output 818 and/or input 816 may include a data collection apparatus associated with computer system 800. In addition, input 816, which commonly includes a computer keyboard and/or pointing device such as a computer mouse, computer track pad, or the like, allows a user to input instructions to computer system 800. A user interface can be provided using output 818 and input 816. Output 818 may function as a display for displaying data and information for a user, and for interactively displaying a graphical user interface (GUI) 830.

Note that the term “GUI” generally refers to a type of environment that represents programs, files, options, and so forth by means of graphically displayed icons, menus, and dialog boxes on a computer monitor screen. A user can interact with the GUI to select and activate such options by directly touching the screen and/or pointing and clicking with a user input device 816 such as, for example, a pointing device such as a mouse, and/or with a keyboard. A particular item can function in the same manner to the user in all applications because the GUI provides standard software routines (e.g., module 825) to handle these elements and report the user's actions. The GUI can further be used to display the electronic service image frames as discussed below.

Computer-readable instructions, for example, program module or node 825, which can be representative of other modules or nodes described herein, are stored on a computer-readable medium and are executable by the processing unit 802 of computer 810. Program module or node 825 may include a computer application. A hard drive, CD-ROM, RAM, Flash Memory, and a USB drive are just some examples of articles including a computer-readable medium.

FIG. 9 depicts a graphical representation of a network of data-processing systems 900 in which aspects of the present invention may be implemented. Network data-processing system 900 can be a network of computers or other such devices, such as mobile phones, smart phones, sensors, controllers, actuators, speakers, “internet of things” devices, and the like, in which embodiments of the present invention may be implemented. Note that the system 900 can be implemented in the context of a software module such as program module 825. The system 900 includes a network 902 in communication with one or more clients 910, 912, and 914. Network 902 may also be in communication with one or more devices 904, servers 906, and storage 908. Network 902 is a medium that can be used to provide communications links between various devices and computers connected together within a networked data processing system such as computer system 800. Network 902 may include connections such as wired communication links, wireless communication links of various types, and fiber optic cables. Network 902 can communicate with one or more servers 906, one or more external devices such as device 904, and a memory storage unit such as, for example, memory or database 908. It should be understood that device 904 may be embodied as a detector device, controller, receiver, transmitter, transceiver, transducer, driver, signal generator, testing apparatus, or other such device.

In the depicted example, device 904, server 906, and clients 910, 912, and 914 connect to network 902 along with storage unit 908. Clients 910, 912, and 914 may be, for example, personal computers or network computers, handheld devices, mobile devices, tablet devices, smart phones, personal digital assistants, controllers, recording devices, speakers, MFDs, etc. Computer system 800 depicted in FIG. 8 can be, for example, a client such as client 910 and/or 912 and/or 914.

Computer system 800 can also be implemented as a server such as server 906, depending upon design considerations. In the depicted example, server 906 provides data such as boot files, operating system images, applications, and application updates to clients 910, 912, and/or 914. Clients 910, 912, and 914 and device 904 are clients to server 906 in this example. Network data-processing system 900 may include additional servers, clients, and other devices not shown. Specifically, clients may connect to any member of a network of servers, which provide equivalent content.

In the depicted example, network data-processing system 900 is the Internet, with network 902 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, government, educational, and other computer systems that route data and messages. Of course, network data-processing system 900 may also be implemented as a number of different types of networks such as, for example, an intranet, a local area network (LAN), or a wide area network (WAN). FIGS. 8 and 9 are intended as examples and not as architectural limitations for different embodiments of the present invention.

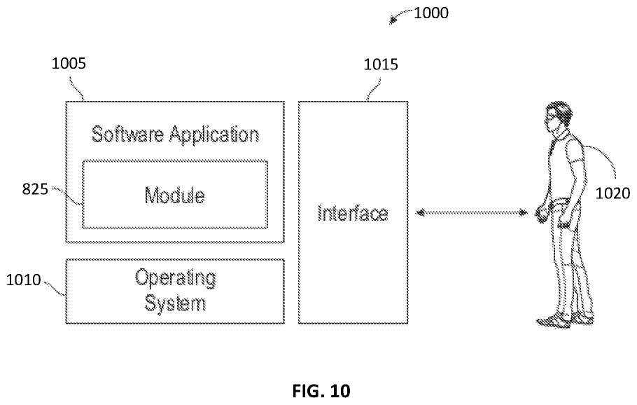

FIG. 10 illustrates a software system 1000, which may be employed for directing the operation of the data-processing systems such as computer system 800 depicted in FIG. 8. Software application 1005, may be stored in memory 804, on removable storage 812, or on non-removable storage 814 shown in FIG. 8, and generally includes and/or is associated with a kernel or operating system 1010 and a shell or interface 1015. One or more application programs, such as module(s) or node(s) 825, may be “loaded” (i.e., transferred from removable storage 814 into the memory 804) for execution by the data-processing system 800. The data-processing system 800 can receive user commands and data through user interface 1015, which can include input 816 and output 818, accessible by a user 1020. These inputs may then be acted upon by the computer system 800 in accordance with instructions from operating system 1010 and/or software application 1005 and any software module(s) 825 thereof.

Generally, program modules (e.g., module 825) can include, but are not limited to, routines, subroutines, software applications, programs, objects, components, data structures, etc., that perform particular tasks or implement particular abstract data types and instructions. Moreover, those skilled in the art will appreciate that elements of the disclosed methods and systems may be practiced with other computer system configurations such as, for example, hand-held devices, mobile phones, smart phones, tablet devices multi-processor systems, microcontrollers, printers, copiers, fax machines, multi-function devices, data networks, microprocessor-based or programmable consumer electronics, networked personal computers, minicomputers, mainframe computers, servers, medical equipment, medical devices, and the like.

Note that the term “module” or “node” as utilized herein may refer to a collection of routines and data structures that perform a particular task or implements a particular abstract data type. Modules may be composed of two parts: an interface, which lists the constants, data types, variables, and routines that can be accessed by other modules or routines; and an implementation, which is typically private (accessible only to that module), and which includes source code that actually implements the routines in the module. The term module may also simply refer to an application such as a computer program designed to assist in the performance of a specific task such as word processing, accounting, inventory management, etc., or a hardware component designed to equivalently assist in the performance of a task.

The interface 1015 (e.g., a graphical user interface 830) can serve to display results, whereupon a user 1020 may supply additional inputs or terminate a particular session. In some embodiments, operating system 1010 and GUI 830 can be implemented in the context of a “windows” system. It can be appreciated, of course, that other types of systems are possible. For example, rather than a traditional “windows” system, other operation systems such as, for example, a real-time operating system (RTOS) more commonly employed in wireless systems may also be employed with respect to operating system 1010 and interface 1015. The software application 1005 can include, for example, module(s) 825, which can include instructions for carrying out steps or logical operations such as those shown and described herein.

The following description is presented with respect to embodiments of the present invention, which can be embodied in the context of, or require the use of, a data-processing system such as computer system 800, in conjunction with program module 825, and data-processing system 900 and network 902 depicted in FIGS. 8-10. The present invention, however, is not limited to any particular application or any particular environment. Instead, those skilled in the art will find that the system and method of the present invention may be advantageously applied to a variety of system and application software including database management systems, word processors, and the like. Moreover, the present invention may be embodied on a variety of different platforms including Windows, Macintosh, UNIX, LINUX, Android, Arduino, LabView and the like. Therefore, the descriptions of the exemplary embodiments, which follow, are for purposes of illustration and not considered a limitation.

Based on the foregoing, it can be appreciated that a number of embodiments, preferred and alternative, are disclosed herein. In an embodiment, a filter fabrication method comprises forming an ultrafiltration (UF) membrane, immersing the UF membrane in a glycerol solution, and lasing a surface of the membrane. In an embodiment, the membrane comprises poly(ethersulfone).

In an embodiment of the method lasing a surface of the membrane further comprises lasing a top surface of the membrane. In an embodiment of the method, lasing a surface of the membrane further comprises lasing a bottom surface of the membrane. In an embodiment of the method, lasing a surface of the membrane further comprises forming a graphene layer on the surface of the membrane. In an embodiment of the method, lasing a surface of the membrane further comprises adjusting parameters of a laser according to desired properties of the graphene layer. In an embodiment of the method, lasing a surface of the membrane further comprises applying a laser comprising a Carbon dioxide infrared laser.

In an embodiment of the method, forming a membrane further comprises a nonsolvent induced phase separation form a polymer doped solution.

In an embodiment, a filter fabrication method comprises immersing an ultrafiltration (UF) membrane in a glycerol solution, removing excess glycerol from the UF membrane, and lasing a surface of the membrane.

In an embodiment of the method, lasing a surface of the membrane further comprises lasing a top surface of the membrane. In an embodiment of the method, lasing a surface of the membrane further comprises lasing a bottom surface of the membrane. In an embodiment of the method, lasing a surface of the membrane further comprises forming a graphene layer on the surface of the membrane. In an embodiment of the method, lasing a surface of the membrane further comprises adjusting parameters of a laser according to desired properties of the graphene layer. In an embodiment of the method, lasing a surface of the membrane further comprises applying a laser comprising a Carbon dioxide infrared laser.

In an embodiment the method further comprises drying the UF membrane after excess glycerol is removed.

In an embodiment the method further comprises forming a UF membrane. In an embodiment, the method further comprises dissolving poly(ethersulfone) (PES) in N-Methyl-2-Pyrrolidone (NMP) to create a solution, cooling the solution to room temperature, removing air bubbles from the solution, spreading the solution on a substrate, immersing the solution on the substrate in a water coagulation bath, and removing residual solvent.

In an embodiment, a filter comprises a poly(ethersulfone) (PES) membrane, a graphene layer formed on the PES membrane, a microporous structure associated with the graphene layer, and a bottom surface. In an embodiment, the PES membrane comprises a PES Veradel 3000P Mw˜65,000 g mol−1. In an embodiment, the graphene layer is formed by lasing the PES membrane.

It will be appreciated that variations of the above-disclosed and other features and functions, or alternatives thereof, may be desirably combined into many other different systems or applications. Also, it should be appreciated that various presently unforeseen or unanticipated alternatives, modifications, variations, or improvements therein may be subsequently made by those skilled in the art which are also intended to be encompassed by the following claims.

What is claimed is:

1. A filter fabrication method comprising:
forming a ultrafiltration (UF) membrane;
immersing the UF membrane in a glycerol solution; and
lasing a surface of the membrane.

2. The filter fabrication method of claim 1 wherein the membrane comprises poly(ethersulfone).

3. The filter fabrication method of claim 1 wherein lasing a surface of the membrane further comprises:
lasing a top surface of the membrane.

4. The filter fabrication method of claim 1 wherein lasing a surface of the membrane further comprises:
lasing a bottom surface of the membrane.

5. The filter fabrication method of claim 1 wherein lasing a surface of the membrane further comprises:
forming a graphene layer on the surface of the membrane.

6. The filter fabrication method of claim 5 wherein lasing a surface of the membrane further comprises:
adjusting parameters of a laser according to desired properties of the graphene layer.

7. The filter fabrication method of claim 1 wherein lasing a surface of the membrane further comprises:
applying a laser comprising a Carbon dioxide infrared laser.

8. The filter fabrication method of claim 1 wherein forming a membrane further comprises:
a nonsolvent induced phase separation form a polymer doped solution.

9. A filter fabrication method comprising:
immersing an ultrafiltration (UF) membrane in a glycerol solution;
removing excess glycerol from the UF membrane; and
lasing a surface of the membrane.

10. The filter fabrication method of claim 9 wherein lasing a surface of the membrane further comprises:
lasing a top surface of the membrane.

11. The filter fabrication method of claim 9 wherein lasing a surface of the membrane further comprises:
lasing a bottom surface of the membrane.

12. The filter fabrication method of claim 9 wherein lasing a surface of the membrane further comprises:
forming a graphene layer on the surface of the membrane.

13. The filter fabrication method of claim 9 wherein lasing a surface of the membrane further comprises:
adjusting parameters of a laser according to desired properties of the graphene layer.

14. The filter fabrication method of claim 9 wherein lasing a surface of the membrane further comprises:
applying a laser comprising a Carbon dioxide infrared laser.

15. The filter fabrication method of claim 9 further comprising:
drying the UF membrane after excess glycerol is removed.

16. The method of claim 9 further comprising:
forming a UF membrane.

17. The method of claim 16 wherein forming the UF membrane further comprises:
dissolving poly(ethersulfone) (PES) in N-Methyl-2-Pyrrolidone (NMP) to create a solution;
cooling the solution to room temperature;
removing air bubbles from the solution;
spreading the solution on a substrate;
immersing the solution on the substrate in a water coagulation bath; and
removing residual solvent.

18. A filter comprising:
a poly(ethersulfone) (PES) membrane;
a graphene layer formed on the PES membrane;
a microporous structure associated with the graphene layer; and
a bottom surface.

19. The filter of claim 18 wherein the PES membrane comprises:
a PES Veradel 3000P Mw˜65,000 g mol−1.

20. The filter of claim 18 wherein the graphene layer is formed by lasing the PES membrane.
